(19) United States
(12) Patent Application Publication
(10) Pub. No.: US 2024/0132084 A1
(43) Pub. Date: Apr. 25, 2024

(54) METHOD AND SYSTEM FOR RECOGNIZING OBJECT

(71) Applicants: HYUNDAI MOTOR COMPANY, Seoul (KR); KIA CORPORATION, Seoul (KR)

(72) Inventors: Kyeong Eun Kim, Gunpo-si (KR); Se Jong Heo, Anyang-si (KR); Kyeong Jin Jeon, Goyang-si (KR)

(73) Assignees: HYUNDAI MOTOR COMPANY, Seoul (KR); KIA CORPORATION, Seoul (KR)

(21) Appl. No.: 18/229,440

(22) Filed: Aug. 2, 2023

(30) Foreign Application Priority Data
Oct. 12, 2022 (KR) 10-2022-0130349

(51) Int. Cl. B60W 50/02; B60W 40/02

(52) U.S. Cl. CPC B60W 50/0205; B60W 40/02; B60W 2050/0056; B60W 2554/20

(57) ABSTRACT

An object detection method includes determining an error parameter associated with an amount of movement of a vehicle through a predetermined regression method based on positioning information of the vehicle and dynamics information of the vehicle with respect to a predetermined center of gravity of the vehicle, determining a velocity of a predetermined point of the vehicle, based on a fixed error parameter stored in a memory or a corrected fixed error parameter, through a comparison between the error parameter and the fixed error parameter, generating a local map in consideration of the amount of movement of the vehicle based on the determined velocity, and detecting an object around the vehicle based on the local map.

### CROSS-REFERENCE TO RELATED APPLICATION

The present application claims priority to Korean Patent Application No. 10-2022-0130349, filed on Oct. 12, 2022, the entire contents of which is incorporated herein for all purposes by this reference.

### BACKGROUND OF THE PRESENT DISCLOSURE

### Field of the Present Disclosure

The present disclosure relates to an object detection method and system for a vehicle.

### Description of Related Art

Due to the sparse geometric information related to static objects obtained via a sensing device of a vehicle, it is common to accumulate the obtained information over a predetermined time period to generate a map, for example, a local map.

When generating the local map, a system of the vehicle may compensate for an amount of movement of the vehicle (or a subject vehicle) with respect to a reference coordinate system of the map to dispose sensing information related to a surrounding environment on the map. If such a process fails to accurately compensate for an amount of movement of the vehicle, there may be an error in the local map. Therefore, accurate estimation of an amount of movement of a vehicle may be an important factor in improving the performance of recognizing an object, for example, a static object.

To compensate for an amount of movement of a vehicle, it is necessary to convert velocity information which is based on the center of gravity of the vehicle to velocity information which is based on a vehicle coordinate system (an origin point: the center portion of a front bumper) of the vehicle. In the instant case, due to a change in the center of gravity by the boarding of a passenger or the composition of the vehicle, or a scale factor and bias of a wheel speed sensor of the vehicle, there may be a great error in estimating an amount of movement of the vehicle.

Traditionally, to accurately estimate the center of gravity of a vehicle, a technique of additionally using a separate sensor or a technique of changing a dynamic model of the vehicle has been applied.

However, the technique of additionally using a separate sensor may include a disadvantage in that an additional sensor is permanently provided. Furthermore, the technique of changing a dynamic model of a vehicle may include a disadvantage in that a change in the center of gravity by a change in the composition of the vehicle or the boarding of a passenger may not be estimated.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an object detection method and system which may improve the performance of detecting a static object by improving the quality of a map, for example, a local map, of a vehicle.

For example, the object detection method and system of the present disclosure may estimate a movement amount error parameter of the vehicle including the center of gravity of the vehicle (or subject vehicle) using position information of the vehicle. The position information may be obtained by a removable precise Global Positioning System (GPS) sensor and/or by a localization module of the vehicle which performs the localization of the vehicle through a map matching process.

For example, the object detection method and system of the present disclosure may precisely compensate for velocity information in a vehicle coordinate system and may therefore improve the quality of the local map and improve the performance of recognizing a static object.

An object detection method according to an exemplary embodiment of the present disclosure includes determining an error parameter associated with an amount of movement of a vehicle through a predetermined regression method based on positioning information of the vehicle and dynamics information of the vehicle with respect to a predetermined center of gravity of the vehicle, determining a velocity of a predetermined point of the vehicle, based on a fixed error parameter stored in a memory or a corrected fixed error parameter, through a comparison between the error parameter and the fixed error parameter, generating a local map in consideration of the amount of movement of the vehicle based on the determined velocity, and detecting an object around the vehicle based on the local map.

In at least an exemplary embodiment of the present disclosure, the method further includes correcting the fixed error parameter via a low-pass filter (LPF) to generate the corrected fixed error parameter in response to a difference between the error parameter and the fixed error parameter being greater than or equal to a predetermined threshold value.

In at least an exemplary embodiment of the present disclosure, the determining of the velocity includes determining the velocity based on the corrected fixed error parameter in response to the difference being greater than or equal to the predetermined threshold value, and determining the velocity based on the fixed error parameter in response to the difference being less than the predetermined threshold value.

In at least an exemplary embodiment of the present disclosure, the fixed error parameter is determined and provided through prior learning by an external system of the vehicle.

In at least an exemplary embodiment of the present disclosure, the fixed error parameter includes a scale factor of an output velocity of a vehicle dynamics input signal processing (VDISP) sensor of the vehicle, a bias of the output velocity, and a vector from the center of gravity of the vehicle to the predetermined point of the vehicle.

In at least an exemplary embodiment of the present disclosure, the dynamics information includes a first velocity and a yaw rate output from a VDISP sensor of the vehicle, and the determining of the error parameter associated with the amount of movement of the vehicle is performed based on a second velocity of the vehicle determined based on the positioning information of the vehicle.

In at least an exemplary embodiment of the present disclosure, the error parameter associated with the amount of movement of the vehicle includes a scale factor of the first velocity, a bias of the first velocity, and a vector from the predetermined center of gravity to the predetermined point of the vehicle.

In at least an exemplary embodiment of the present disclosure, the amount of movement of the vehicle is determined by integrating a longitudinal velocity and a lateral velocity included in the determined velocity.

In at least an exemplary embodiment of the present disclosure, the generating of the local map includes generating the local map including data output from an object detection sensor of the vehicle, based on pre-stored map data, the amount of movement of the vehicle, the positioning information of the vehicle, and the data output from the object detection sensor.

In at least an exemplary embodiment of the present disclosure, the local map includes a grid map, wherein the detecting of the object includes determining a score for each grid based on a number of data output from the object detection sensor and accumulated therein for a predetermined time period, and in response to an average value of scores of neighboring grids which include the data being greater than or equal to a predetermined threshold value, determining data of the neighboring grids as data of a static object.

An object detection system according to an exemplary embodiment of the present disclosure includes an interface configured to receive, from a sensing device of a vehicle, positioning information of the vehicle and dynamics information with respect to a predetermined center of gravity of the vehicle, a memory configured to store a fixed error parameter, and a processor electrically or communicatively connected to the interface and the memory, wherein the processor is configured to determine an error parameter associated with an amount of movement of the vehicle through a predetermined regression method based on the positioning information and the dynamics information, determine a velocity of a predetermined point of the vehicle, through a comparison between the error parameter and the fixed error parameter, based on the fixed error parameter or a corrected fixed error parameter, generate a local map in consideration of the amount of movement of the vehicle based on the determined velocity, and detect an object around the vehicle based on the local map.

In at least an exemplary embodiment of the system, the processor is further configured to in response to a difference between the error parameter and the fixed error parameter being greater than or equal to a predetermined threshold value, correct the fixed error parameter via a low-pass filter (LPF) to generate the corrected fixed error parameter.

In at least an exemplary embodiment of the system, the processor is further configured to in response to the difference being greater than or equal to the predetermined threshold value, determine the velocity of the predetermined point of the vehicle based on the corrected fixed error parameter, and in response to the difference being less than the predetermined threshold value, determine the velocity of the predetermined point of the vehicle based on the fixed error parameter.

In at least an exemplary embodiment of the system, the fixed error parameter is determined through prior learning by an external system of the vehicle and provided via the interface.

In at least an exemplary embodiment of the system, the fixed error parameter includes a scale factor of an output velocity of a vehicle dynamics input signal processing (VDISP) sensor of the vehicle, a bias of the output velocity, and a vector from the center of gravity of the vehicle to the predetermined point of the vehicle.

In at least an exemplary embodiment of the system, the dynamics information includes a first velocity and a yaw rate output from a VDISP sensor of the vehicle, and the processor is further configured to determine the error parameter associated with the amount of movement of the vehicle based on a second velocity of the vehicle determined based on the positioning information of the vehicle.

In at least an exemplary embodiment of the system, the error parameter associated with the amount of movement of the vehicle includes a scale factor of the first velocity, a bias of the first velocity, and a vector from the predetermined center of gravity to the predetermined point of the vehicle.

In at least an exemplary embodiment of the system, the processor is further configured to determine the amount of movement of the vehicle by integrating a longitudinal velocity and a lateral velocity comprised in the determined velocity.

In at least an exemplary embodiment of the system, the memory is further configured to store map data, wherein the processor is further configured to generate the local map including data output from an object detection sensor of the vehicle, based on the map data, the amount of movement of the vehicle, the positioning information of the vehicle, and the data output from the object detection sensor.

In at least an exemplary embodiment of the system, the local map includes a grid map, and wherein the processor is further configured to determine a score for each grid based on a number of data output from the object detection sensor and accumulated therein for a predetermined time period and in response to an average value of scores of neighboring grids which include the data being greater than or equal to a predetermined threshold value, determine data of the neighboring grids as data of a static object.

The object detection method and system according to the exemplary embodiments of the present disclosure may improve the accuracy of an amount of movement of a vehicle.

For example, the object detection method and system according to the exemplary embodiments of the present disclosure may estimate, in real time, the center of gravity of the vehicle that changes according to a reconstruction of the vehicle and/or the boarding of a passenger in the vehicle.

Furthermore, for example, the object detection method and system according to the exemplary embodiments of the present disclosure may compensate for an error in an amount of movement of the vehicle by a scale factor and a bias, which are output data of a vehicle dynamics input signal processing (VDISP) module of the vehicle, and by a change in the center of gravity of the vehicle.

The object detection method and system according to the exemplary embodiments of the present disclosure may reduce such an error in an amount of movement of the vehicle to improve the accuracy and geometric consistency of a local map used for controlling the driving of the vehicle, improving the performance of recognizing a static object. Furthermore, as the static object recognizing performance is improved, it may also improve the performance of a positioning and decision logic for controlling the driving of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an example of determining an amount of movement of a vehicle according to the related art and an exemplary embodiment of the present disclosure.

FIG. 2 is a block diagram illustrating a vehicle according to an exemplary embodiment of the present disclosure.

FIGS. 3A and 3B are a graph showing a result of determining an amount of movement of a vehicle according to an exemplary embodiment of the present disclosure.

FIGS. 4A and 4B are a diagram illustrating an example of recognizing an object around a vehicle according to an exemplary embodiment of the present disclosure.

FIG. 5 is a flowchart illustrating operations of an object detection system of a vehicle according to an exemplary embodiment of the present disclosure.

FIG. 6A, FIG. 6B and FIG. 6C are images showing a result of outputting a map including a local map according to the related art and an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Throughout the present specification, like reference numerals refer to like elements. The specification does not describe all elements of embodiments of the present disclosure, and general or overlapping content between the exemplary embodiments in the Field of the present disclosure to which the present disclosure pertains will be omitted. Terms such as, “unit,” “module,” or “device” used herein may be implemented in software or hardware, and according to various exemplary embodiments of the present disclosure, a plurality of “units,” “modules,” or “devices” may be implemented as a single component or a single “unit,” “module,” or “device” may include a plurality of components.

Throughout the specification, when an element is referred to as being “coupled” or “connected” to another element, the element may be directly coupled or connected to the other element. It should be understood, however, that another element may be present therebetween.

Furthermore, it should be understood herein that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

Although terms including ordinal numbers, such as “first,” “second,” etc., may be used herein to describe various elements, the elements are not limited by these terms. These terms are generally used to distinguish one element from another.

The singular forms “a,” “an,” and “the” are intended to include the plural forms as well, unless the context clearly indicates otherwise.

Throughout the specification, reference numerals or reference numerals are used for the convenience of description and provided to describe the order of each step or operation, but each step or operation may also be performed in different orders unless a specific order is clearly described in context.

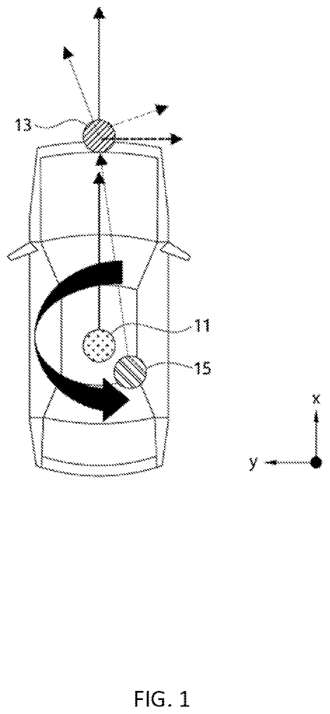

FIG. 1 is a diagram illustrating an example of determining an amount of movement of a vehicle according to the related art and an exemplary embodiment of the present disclosure.

To recognize an object, for example, a static object, it may be necessary to determine an amount of movement of a vehicle (or a subject vehicle). The amount of movement of the vehicle may be determined by integrating a longitudinal velocity and a lateral velocity of the vehicle in a vehicle coordinate system through dead reckoning.

Referring to FIG. 1, dynamics information (or velocity information) of the vehicle including a longitudinal velocity and a lateral velocity of the vehicle may be based on or relative to a predetermined center of gravity 11 (or a predetermined position of the center of gravity) of the vehicle as shown in FIG. 1.

To determine an amount of movement of the vehicle based on the dynamics information, it may be necessary to convert the velocity information with respect to the predetermined center of gravity 11 to one with respect to a predetermined point, e.g., a center portion of a front bumper 13 (or a front bumper center position) of the vehicle which may be defined as the origin of the vehicle coordinate system.

In the conversion of the velocity information from the predetermined center of gravity 11 to the center portion of the front bumper 13 of the vehicle coordinate system, an amount of velocity compensation by a rotation of the vehicle may be a function of a position vector from the predetermined center of gravity 11 of the vehicle to the center portion of the front bumper 13 of the vehicle and a yaw rate.

That is, to determine an actual velocity of the vehicle relative to the center portion of the front bumper 13 in the vehicle coordinate system, it is necessary to compensate for the velocity of the vehicle by considering a function of a movement vector from the center of gravity 11 of the vehicle to the center portion of the front bumper 13 and the yaw rate.

According to the related art, the velocity information may be converted from the predetermined center of gravity 11 (or the predetermined position of the center of gravity) to the center portion of the front bumper 13 (or the front bumper center position) of the vehicle coordinate system, and then an amount of movement of the vehicle may be determined based on the converted velocity information.

For example, generally, the predetermined center of gravity 11 of the vehicle may be assumed to be free from errors, and based on the velocity information relative to the predetermined center of gravity 11, a velocity Vo of the vehicle relative to the center portion of the front bumper 13 of the vehicle in the vehicle coordinate system may be determined, using Equation 1 below.

$${v}_{o} = [ \begin{matrix}{υ}_{{x}_{i}} \\ {υ}_{{y}_{i}}\end{matrix} ] = [ \begin{matrix}{\tilde{υ}}_{{x}_{i}} \\ {\tilde{υ}}_{{y}_{i}}\end{matrix} ] + [ \begin{matrix}0 & - \dot{ψ} \\ \dot{ψ} & 0\end{matrix} ] [ \begin{matrix}{r}_{x} \\ {r}_{y}\end{matrix} ] \qquad [ Equation 1 ]$$

(v: actual velocity information of the vehicle, \tilde{ν}: output velocity information of a vehicle dynamics input signal processing (VDISP) sensor, \dot{ψ}: a yaw rate of the vehicle, r: a movement vector from the center of gravity of the vehicle to the center portion of a front bumper of the vehicle, x: an x-axis coordinate value in the vehicle coordinate system, y: a y-axis coordinate value in the vehicle coordinate system, i: an integer representing data sequence (or step number).

The velocity Vo of the vehicle determined as described above may be inaccurate because an accurate center of gravity (or a change of the center of gravity) of the vehicle is not considered.

For example, the center of gravity of a vehicle may vary for each type or model of vehicle, and the center of gravity of a vehicle may change in real time based on an occupancy position of a passenger in the vehicle and/or a state of loading.

According to the related art, an amount of movement of a vehicle may be determined based on a velocity which is determined without consideration of an actual center of gravity 15 of the vehicle, and the determined amount of movement of the vehicle may thus include an error.

To minimize the present error, it is necessary to determine a velocity of the vehicle in consideration of a movement vector from the actual center of gravity 15 of the vehicle to the center portion of a front bumper of the vehicle, and determine an amount of movement of the vehicle based on the velocity determined as described above.

Accordingly, the exemplary embodiments of the present disclosure may be configured to determine velocity information of a vehicle relative to the vehicle coordinate system, in consideration that there is a difference between the predetermined center of gravity (also referred to herein as a “fixed center of gravity”) and the actual center of gravity 15 of the vehicle, and may therefore minimize an error in the velocity information relative to the vehicle coordinate system and an amount of movement of the vehicle based on the velocity information of the vehicle.

Furthermore, when generating and/or updating a local map including data output from a sensing device (e.g., a Light Detection and Ranging (LiDAR), a radio detection and ranging (RADAR), and/or a camera), a large error in an amount of movement of the vehicle may result in inconsistency in the geometric shape of data indicated on the local map and an abnormal update of the probability of presence of the data in the local map.

This may reduce the quality of the local map used to recognize an object (e.g., a static object) present around the vehicle, and may lead to misrecognition (or non-recognition) of the object.

According to an exemplary embodiment of the present disclosure, minimizing an error in an amount of movement of a vehicle may improve the quality of a local map generated based on the amount of movement of the vehicle and minimize the misrecognition (or non-recognition) of an object.

Hereinafter, the operational principles and embodiments of the present disclosure will be described with reference to the accompanying drawings.

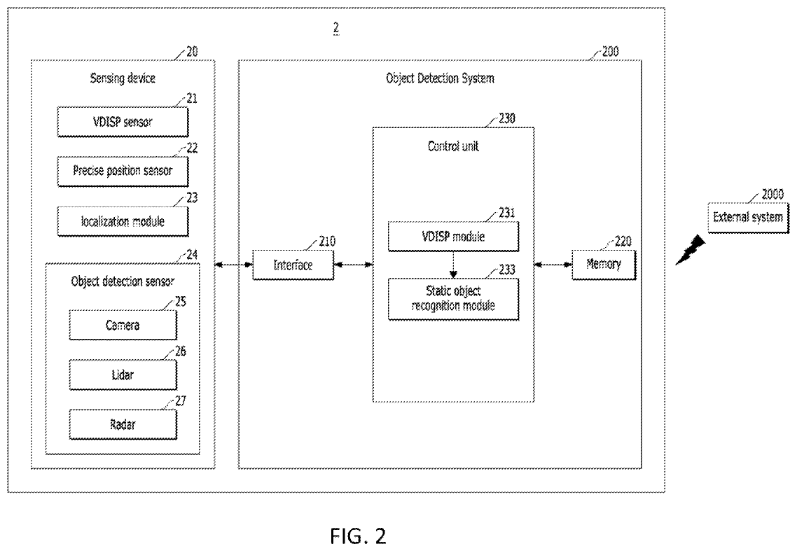

FIG. 2 is a block diagram illustrating a vehicle according to an exemplary embodiment of the present disclosure.

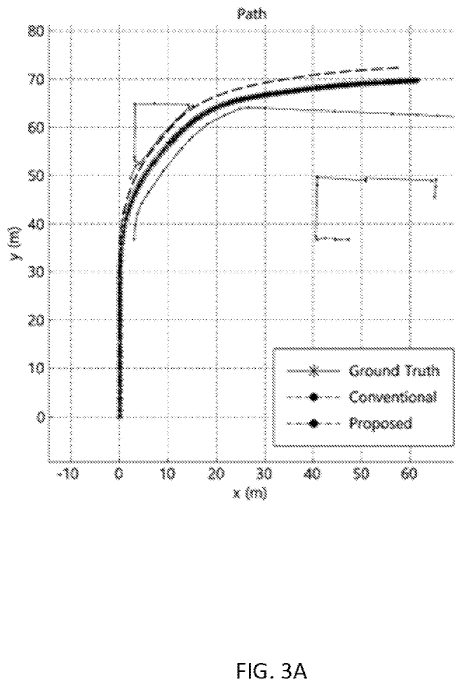

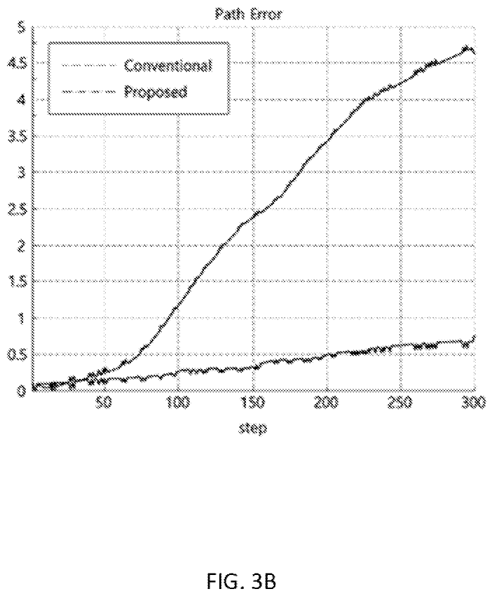

FIGS. 3A and 3B are a graph showing a result of determining an amount of movement of a vehicle according to an exemplary embodiment of the present disclosure.

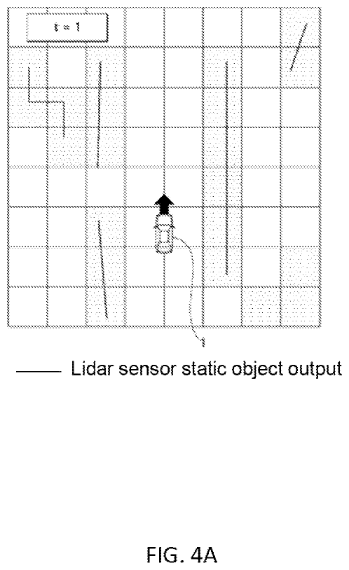

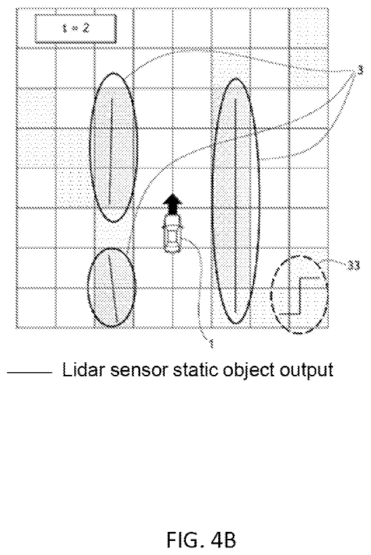

FIGS. 4A and 4B are a diagram illustrating an example of recognizing an object around a vehicle according to an exemplary embodiment of the present disclosure.

Referring to FIG. 2, a vehicle 2 may include a sensing device 20 and an object detection system 200.

The sensing device 20 may include one or more devices configured to obtain information related to the vehicle 2 and/or information related to objects present around the vehicle 2.

The sensing device 20 may include a VDISP sensor 21, a precise position sensor 22, a localization module 23, and/or an object detection sensor 24.

The VDISP sensor 21 may include one or more sensors provided in the vehicle 2 to obtain and output data to be used to determine dynamics information (e.g., velocity) of the vehicle 2.

For example, the VDISP sensor 21 may include an acceleration sensor configured for measuring and output an acceleration of the vehicle 2 and/or a wheel speed sensor configured for measuring and output a wheel speed of the vehicle 2.

The precise position sensor 21 may obtain and output positioning information (also referred to as position information) of the vehicle 2.

The precise position sensor 21 may include, for example, a global positioning system (GPS) and/or differential GPS (DGPS) to provide the positioning information of the vehicle 2.

The localization module 23 may obtain and output the positioning information of the vehicle 2.

For example, the localization module 23 may obtain and output the positioning information of the vehicle 2, using a positioning logic that estimates a current position of the vehicle 2 through map matching based on information such as lanes and/or road boundaries.

The object detection sensor 24 may include a camera 25, a LiDAR 26, and/or a radar 27.

The camera 25 may obtain image data of the surroundings of the vehicle 2 and monitor the surroundings of the vehicle 2.

The camera 25 may include, for example, a wide-angle camera, a front camera, a right-facing camera, a left-facing camera, and/or a rear-side view camera.

The LiDAR 26 may detect objects by scanning the surroundings of the vehicle 2.

For example, the LiDAR 26 may be provided as a single LiDAR or a plurality of LiDARs and provided outside the body of the vehicle 2 to emit a laser pulse toward the surroundings of the vehicle 2 and generate LiDAR data, that is, point cloud data (hereinafter also simply referred to as data).

The radar 27 may detect objects around the vehicle 2.

For example, the radar 27 may include a front radar provided at the front of the vehicle 2, a first corner radar provided on the front right side of the vehicle 2, a second corner radar provided on the front left side of the vehicle 2, a third corner radar provided on the rear right side of the vehicle 2, and/or a fourth corner radar provided on the rear left side of the vehicle 2, to include a sensing field of view (FOV) facing the front, front right, front left, rear right, and/or rear left side of the vehicle 2.

The object detection system 200 may include an interface 210, a memory 220, and/or a control unit 230.

The interface 210 may transfer commands or data input from another device (e.g., the sensing device 20) or a user of the vehicle 2 to another component of the object detection system 200, or may output commands or data received from the other component of the object detection system 200 to the other device of the vehicle 2.

The interface 210 may include a communication module to communicate with another device (e.g., the sensing device 20) of the vehicle 2 and/or an external system 2000 outside the vehicle 2.

For example, the communication module may include a communication module configured to enable communication between devices of the vehicle 2, for example, Controller Area Network (CAN) communication and/or Local Interconnect Network (LIN) communication, over a vehicle communication network. Furthermore, the communication module may include a wired communication module (e.g., a power line communication module) and/or a wireless communication module (e.g., a cellular communication module, a Wi-Fi communication module, a short-range wireless communication module, or a global navigation satellite system (GNSS) communication module).

The memory 220 may store various data used by at least one component of the object detection system 200, for example, input data and/or output data for software programs and commands related thereto.

The memory 220 may include a non-volatile memory such as cache, read-only memory (ROM), programmable ROM (PROM), erasable programmable ROM (EPROM), electrically erasable programmable ROM (EEPROM), and/or flash memory, and/or a volatile memory such as random-access memory (RAM).

The memory 220 may store map data.

Furthermore, the memory 220 may store a fixed error parameter associated with an amount of movement of the vehicle 2.

The fixed error parameter may be determined through prior learning by the external system 2000 of the vehicle 2 or an internal system or the control unit 230 of the vehicle 2, and may be stored in the memory 220 via the interface 210.

To determine the fixed error parameter, through the driving (or test driving) of the vehicle 2, driving-related data including positioning information (or precise positioning data) of the vehicle 2 and dynamics information of the vehicle 2 may be obtained.

For example, the positioning information of the vehicle 2 may be information relative to the center portion of a front bumper in a vehicle coordinate system, and the dynamics information of the vehicle 2 may be information relative to the center of gravity of the vehicle 2.

For example, the center of gravity, which is the center of gravity the vehicle 2 has on average while driving, may be determined in advance.

For example, in a state where a differential global positioning system (DGPS) is provided in the vehicle 2 and passengers are evenly distributed in the vehicle 2, the control unit 230 of the vehicle 2 may collect the driving-related data including the positioning information obtained via the DGPS and the dynamics information of the vehicle 2 obtained via the VDISP sensor 21.

Furthermore, the control unit 230 of the vehicle 2 may collect the positioning information and the driving-related data of the vehicle 2 for a long time period while controlling the driving of the vehicle 2 so that a velocity and yaw angular velocity of the vehicle 2 are output above a certain amount to increase the reliability of the fixed error parameter associated with an amount of movement of the vehicle 2.

If the fixed error parameter is determined based on data obtained while the vehicle 2 is in a stationary state, a rank of Equation 3 to be described below may become insufficient, and the fixed error parameter may be misestimated. Therefore, when collecting data from the vehicle 2 for prior learning, the stationary state of the vehicle 2 may not be considered.

The external system 2000, the internal system, or the control unit 230 of the vehicle 2 may be configured to determine the fixed error parameter associated with an amount of movement of the vehicle 2, through a regression method, based on the driving-related data including the positioning information of the vehicle 2 and the dynamics information of the vehicle 2 collected as described above.

For example, the external system 2000, the internal system, or the control unit 230 of the vehicle 2 may perform a regression analysis using Equation 2 below to estimate a movement vector from the center of gravity of the vehicle 2 to the center portion of the front bumper of the vehicle 2.

Equation 2, which reflects therein an error of the center of gravity of the vehicle 2, a scale factor of an output velocity of the VDISP sensor 21, and/or a bias of the output velocity of the VDISP sensor 21, may be a model (used for the regression analysis) for converting a velocity relative to the predetermined center of gravity of the vehicle 2 to a velocity Vo relative to the center portion of the front bumper of the vehicle 2 (or relative to the vehicle coordinate system).

$${v}_{o} = [ \begin{matrix}{υ}_{{x}_{i}} \\ {υ}_{{y}_{i}}\end{matrix} ] = [ \begin{matrix}{s}_{x} {\tilde{υ}}_{{x}_{i}} \\ {s}_{y} {\tilde{υ}}_{{y}_{i}}\end{matrix} ] + [ \begin{matrix}0 & - \dot{ψ} \\ \dot{ψ} & 0\end{matrix} ] [ \begin{matrix}{r}_{x} \\ {r}_{y}\end{matrix} ] + [ \begin{matrix}{b}_{x} \\ {b}_{y}\end{matrix} ] \qquad [ Equation 2 ]$$

(v: actual velocity information of the vehicle 2, s: a scale factor of an output velocity of the VDISP sensor 21, \tilde{ν}: the output velocity of the VDISP sensor 21, \dot{ψ}: a yaw rate of the vehicle 2, r: a movement vector from the center of gravity of the vehicle 2 to the center portion of the front bumper, b: a bias of the output velocity of the VDISP sensor 21, x: an x-axis coordinate value in the vehicle coordinate system, y: a y-axis coordinate value in the vehicle coordinate system, i: an integer indicating data sequence (or step number))

The actual velocity information of the vehicle 2 in Equation 2 above may be data (i.e., velocity) output from the precise position sensor 22 or the localization module 23 of the vehicle 2.

The fixed error parameter may include a scale factor of an output velocity of the VDISP sensor 21, a bias of the output velocity of the VDISP sensor 21, and/or a movement vector from the center of gravity of the vehicle 2 to the center portion of the front bumper of the vehicle 2.

For example, the fixed error parameter may include Sₓ (an output velocity scale factor of the VDISP sensor 21 in an x-axis coordinate value of the vehicle coordinate system), S_{y} (an output velocity scale factor of the VDISP sensor 21 in a y-axis coordinate value of the vehicle coordinate system), rₓ (a movement vector from the center of gravity of vehicle 2 to the center portion of the front bumper in the x-axis coordinate value of the vehicle coordinate system), r_{y} (a movement vector from the center of gravity of vehicle 2 to the center portion of the front bumper in the y-axis coordinate value of the vehicle coordinate system), bₓ (an output velocity bias of the VDISP sensor 21 in the x-axis coordinate value of the vehicle coordinate system), and/or by (an output velocity bias of the VDISP sensor 21 in the y-axis coordinate value of the vehicle coordinate system).

For example, when the precise position sensor 22 is a DGPS, the external system 2000, the internal system, or the control unit 230 of the vehicle 2 may be configured to determine A and B, which are the fixed error parameter, to be applied when changing a reference for a velocity of the vehicle 2 from the center of gravity of the vehicle 2 to the center portion of the front bumper of the vehicle 2, based on data obtained via the DGPS, using Equation 3 below.

$$\begin{matrix}A = [ {S}_{x} , {r}_{y} , {b}_{x} ] \\ {X}_{1} = [ \begin{matrix}{v}_{{x}_{vdisp}}^{1} & {v}_{{x}_{vdisp}}^{2} & … & {v}_{{x}_{vdisp}}^{n} \\ - {\dot{ψ}}_{vdisp}^{1} & - {\dot{ψ}}_{vdisp}^{2} & … & - {\dot{ψ}}_{vdisp}^{n} \\ 1 & 1 & … & 1\end{matrix} ] , {Y}_{1} = [ \begin{matrix}{v}_{{x}_{dgps}}^{1} & {v}_{{x}_{dgps}}^{2} & … & {v}_{{x}_{dgps}}^{n} ]\end{matrix} \\ {AX}_{1} = {Y}_{1} \to A = {Y}_{1} / {X}_{1} \\ B = [ {S}_{y} , {r}_{x} , {b}_{y} ] \\ {X}_{2} = [ \begin{matrix}{v}_{{y}_{vdisp}}^{1} & {v}_{{y}_{vdisp}}^{2} & … & {y}_{vdisp}^{n} \\ {\dot{ψ}}_{vdisp}^{1} & {\dot{ψ}}_{vdisp}^{2} & … & {\dot{ψ}}_{vdisp}^{n} \\ 1 & 1 & … & 1\end{matrix} ] , {Y}_{2} = [ \begin{matrix}{v}_{{y}_{dgps}}^{1} & {v}_{{y}_{dgps}}^{2} & … & {v}_{{y}_{dgps}}^{n} ]\end{matrix} \\ {BX}_{2} = {Y}_{2} \to B = {Y}_{2} / {X}_{2}\end{matrix} \qquad [ Equation 3 ]$$

(νₓ_{_{vdisp}}ⁿ: nth output velocity information of the VDISP sensor 21 in an X-axis coordinate value in the vehicle coordinate system, \dot{ψ}_{vdisp}ⁿ: an nth yaw rate of the VDISP sensor 21, νₓ_{_{dgps}}ⁿ: nth obtained velocity information based on data obtained via the DGPS in the x-axis coordinate value in the vehicle coordinate system, ν_{y}_{_{vdisp}}ⁿ: nth output velocity information of the VDISP sensor 21 in a y-axis coordinate value in the vehicle coordinate system, ν_{y}_{_{dgps}}ⁿ: nth obtained velocity information based on the data obtained via the DGPS in the y-axis coordinate value in the vehicle coordinate system, where n denotes an integer indicating a total number of data used for the regression analysis (or a final time step number))

The control unit 230 (or a control circuit or processor) may be configured for controlling at least one other component of the object detection system 200, for example, a hardware component (e.g., the interface 210 and/or the memory 220) and/or a software component (e.g., a software program), and may perform various data processing and computations.

The control unit 230 may include a VDISP module 231 and a static object detection module 233.

The VDISP module 231 may be configured to determine dynamics information of the vehicle 2 based on data obtained from the VDISP sensor 21.

For example, the VDISP module 231 may be configured to determine the dynamics information of the vehicle 2 based on the predetermined center of gravity in an initial state of the vehicle 2.

For example, the dynamics information determined based on the predetermined center of gravity in the initial state of the vehicle 2 may include a velocity of the vehicle 2, for example, a longitudinal velocity, a lateral velocity, and/or a yaw rate.

However, in practice, the center of gravity of the vehicle 2 may change due to a reconstruction of the vehicle 2 or the boarding of a passenger in the vehicle 2.

The static object detection module 233 may be configured to determine an error parameter associated with an amount of movement of the vehicle 2 based on the obtained positioning information, using the regression method.

For example, the positioning information may include positioning information output from the precise position sensor 22 or the localization module 23.

For example, the static object detection module 233 may collect highly reliable positioning information, a velocity of the vehicle 2 exceeding a threshold value, and a yaw rate of the vehicle 2 exceeding a threshold value, construct a sliding window, and perform the regression analysis.

For example, data used to determine the error parameter in real time, for example, the positioning information, the velocity, and the yaw rate, may be fixed or variable.

For example, the static object detection module 233 may be configured to determine the error parameter associated with an amount of movement of the vehicle 2 in a same manner as the method of determining the fixed error parameter described above, that is, using Equation 3 described above.

The method of determining the error parameter associated with an amount of movement of the vehicle 2 may be almost a same as the method of determining the fixed error parameter described above, except for a difference in that the applied data (e.g., the positioning information and/or the driving-related data) is currently obtained data, and thus a more detailed description of the method of determining the error parameter of the vehicle 2 will be omitted here for conciseness.

Additionally, in Equation 3 for determining the fixed error parameter described above, velocity information obtained via the DGSP is applied. In contrast, for determining the error parameter associated with a current amount of movement of the vehicle 2, velocity information (or a second velocity) determined based on data obtained via a DGSP or Global Positioning System (GPS) of the precise position sensor 21 or the localization module 23 may be applied.

The error parameter may include a scale factor of a velocity (or a first velocity) output from the VDISP sensor 21, a bias of the velocity output from the VDISP sensor 21, and/or a movement vector from the predetermined center of gravity to the center portion of the front bumper.

For example, the error parameter may include Sₓ (an output velocity scale factor of the VDISP sensor 21 in an x-axis coordinate value of the vehicle coordinate system), S_{y} (an output velocity scale factor of the VDISP sensor 21 in a y-axis coordinate value of the vehicle coordinate system), rₓ (a movement vector from the center of gravity of vehicle 2 to the center portion of the front bumper of the vehicle 2 in the x-axis coordinate value of the vehicle coordinate system), r_{y} (a movement vector from the center of gravity of vehicle 2 to the center portion of the front bumper of vehicle 2 in the y-axis coordinate value of the vehicle coordinate system), bₓ (an output velocity bias of the VDISP sensor 21 in the x-axis coordinate value of the vehicle coordinate system), and/or by (an output velocity bias of the VDISP sensor 21 in the y-axis coordinate value of the vehicle coordinate system).

For example, the error parameter may include A and B determined through Equation 3.

The static object detection module 233 may be configured to determine an amount of movement of the vehicle 2 by converting a velocity of the vehicle 2 to that relative to the center portion of the front bumper in the vehicle coordinate system, using the corresponding center of gravity. For example, the static object detection module 233 may reduce an error by compensating for the velocity of the vehicle 2 using the improved information related to the center of gravity and the error parameter associated with a current amount of movement of the vehicle 2.

The static object detection module 233 may correct the amount of movement of the vehicle 2 based on the error parameter determined in real time.

For example, the static object detection module 233 may be configured to determine a velocity of the vehicle 2 relative to the center portion of the front bumper of the vehicle 2, based on the fixed error parameter or a corrected fixed error parameter (or a changed fixed error parameter), through a comparison between the fixed error parameter stored in the memory 220 and the error parameter determined as described above.

For example, when a difference between the fixed error parameter stored in the memory 220 and the error parameter determined as described above is greater than or equal to a threshold value for a predetermined time period, the static object detection module 233 may correct at least one parameter included in the fixed error parameter stored in the memory 220 via a low-pass filter (LPF).

For example, the static object detection module 233 may update the fixed error parameter by changing the fixed error parameter stored in the memory 220 through Equation 4 below, and the updated fixed error parameter may be stored in the memory 220.

A_{corrected}=aA_{fixed}+(1−a)A_{current} B_{corrected}=aB_{fixed}+(1−a)B_{current} [Equation 4]

(A_{current}: A (or each parameter (e.g., Sₓ, r_{y}, or bₓ) of A) determined at a current time step (or an nth step) through Equation 3, A_{fixed}: A (or each parameter (e.g., Sₓ, r_{y}, or bₓ) of A) stored in the memory 220, A_{corrected}: updated A (or each parameter (e.g., Sₓ, r_{y}, or bₓ) of A), B_{current}: B (or each parameter (e.g., S_{y}, rₓ, or b_{y}) of B) determined at the current time step (or the nth step) through Equation 3, B_{fixed}: B (or each parameter (e.g., S_{y}, rₓ, or b_{y}) of B) stored in the memory 220, B_{corrected}: updated B (or each parameter (e.g., S_{y}, rₓ, or b_{y}) of B), a: a predetermined value (0≤a≤1)).

For example, the fixed error parameter may be restored, upon a restart of a program, to its original one, i.e., a fixed error parameter determined through prior learning, and the fixed error parameter updated based on real-time correction may be maintained only during the execution of the program.

The static object detection module 233 may change a velocity of the vehicle 2 relative to the center of gravity of the vehicle 2 to a velocity (Vₓ, V_{y}) of the vehicle 2 relative to the center portion of the front bumper of the vehicle 2, based on the fixed error parameter stored in the memory 220, using Equation 5 below. The velocity of the vehicle 2 relative to the center of gravity of the vehicle 2 may be a velocity included in the dynamics information obtained via the VDISP sensor 21.

In the instant case, the fixed error parameter stored in the memory 220 may be a fixed error parameter that has been changed and updated based on Equation 5. For example, when it is determined that the difference between the fixed error parameter stored in the memory 220 and the determined error parameter is not greater than or equal to the threshold value for the predetermined time period, the fixed error parameter stored in the memory 220 may be a fixed error parameter determined through prior learning and stored thereby.

$$\begin{matrix}{C}_{t} = [ \begin{matrix}{v}_{{x}_{vdisp}}^{t} \\ - {\dot{ψ}}_{vdisp}^{t} \\ 1\end{matrix} ] & {D}_{t} = [ \begin{matrix}{v}_{{y}_{vdisp}}^{t} \\ {\dot{ψ}}_{vdisp}^{t} \\ 1\end{matrix} ] \\ {v}_{x} = A {C}_{t} & {v}_{y} = {BD}_{t}\end{matrix} \qquad [ Equation 5 ]$$

(νₓ_{_{vdisp}}^{t}: velocity information obtained via the VDISP sensor 21 at a current time tin an x-axis coordinate value of the vehicle coordinate system, \dot{ψ}_{vdisp}^{t}: a yaw rate obtained via the VDISP sensor 21 at the current time t, ν_{y}_{_{vdisp}}^{t}: velocity information obtained via the VDISP sensor 21 at the current time tin a y-axis coordinate value of the vehicle coordinate system, A: A stored in the memory 220, B: B stored in the memory 220, Vₓ: an x-axis coordinate velocity relative to the front bumper of the vehicle 2, V_{y}: a y-axis coordinate velocity relative to the front bumper of the vehicle 2)

The static object detection module 233 may be configured to determine an amount of movement of the vehicle 2 based on the velocity (Vₓ and V_{y} determined through Equation 5) of the vehicle 2 determined as described above.

For example, the static object detection module 233 may be configured to determine an amount of movement of the vehicle 2 by integrating a longitudinal velocity and a lateral velocity (Vₓ and V_{y} determined through Equation 5) in the vehicle coordinate system, through dead reckoning.

Referring to FIGS. 3A and 3B, FIG. 3A is a graph showing a generated vehicle movement trajectory, using a fixed error parameter which is finally determined by applying the related art (indicated as “conventional”), a proposed method according to the exemplary embodiments of the present disclosure (indicated as “proposed”), and DGPS data (indicated as “ground truth”). In addition, FIG. 3B is a graph showing an error output when applying the related art and the proposed method according to the exemplary embodiments of the present disclosure.

Referring to FIGS. 3A and 3B, as a result of estimating an error parameter using approximately 10000 data (time step 0.05 s), a value of the fixed error parameter may be finally determined as follows.
A=[1.0118 0 0.0035]
B=[1.2260 2.5004 −0.1097]

Referring to FIG. 3A, it may be verified that, when a velocity of the vehicle 2 is compensated for based on the center portion of the front bumper of the vehicle 2 and an amount of movement of the vehicle 2 is then determined, path data determined according to the exemplary embodiments of the present disclosure is substantially similar to the DGPS data.

Furthermore, referring to FIG. 3B, it may be verified that an error in determining an amount of movement of the vehicle according to the exemplary embodiments of the present disclosure is greatly reduced compared to the related art.

The static object detection module 233 may be configured to generate and/or update a local map including data output from a sensing device 10 of a vehicle 1 for a predetermined time period, based on the amount of movement of the vehicle 2.

For example, the static object detection module 233 may be configured to generate the local map including data output from the object detection sensor 24, based on map data stored in the memory 220, the amount of movement of the vehicle 2, the positioning information of the vehicle 2, and the data output from the object detection sensor 24 of the vehicle 2. For example, the static object detection module 233 may be configured to generate the local map by accumulating the data output from the object detection sensor 24.

For example, the local map may include a grid map (also referred to as a dynamic occupancy grid map). When recognizing a dynamic object using such a grid map, a more accurate estimation of a velocity of the vehicle 2 may be enabled by correcting velocity information included in a result of tracking the dynamic object obtained in the vehicle coordinate system, in a case of occurrence of a yaw angular velocity. Furthermore, when recognizing a dynamic object using the grid map, such velocity compensation may be applied to improve the accuracy of an amount of movement of the vehicle 2.

For example, the static object detection module 233 may update the grid map by compensating for the amount of movement of the vehicle 2 determined according to the described embodiments and accumulating data matched to each grid of the grid map.

The static object detection module 233 may recognize objects around the vehicle 1 based on the local map.

For example, objects around a vehicle or surrounding objects described herein may include static objects and other objects (e.g., dynamic objects, noise, clutter, etc.).

For example, the static object detection module 233 may collect existence probability information of data from the local map, and determine data including a high probability (or high score) to be object (e.g., static object)-related data.

For example, the static object detection module 233 may be configured to determine a score for each grid based on the number of data output from the object detection sensor 24 and accumulated in each grid of the grid map, during a predetermined time period. Furthermore, when an average value of scores of neighboring grids including data in the grid map is greater than or equal to a predetermined threshold value, the static object detection module 233 may be configured to determine the data included in the neighboring grids as the static object-related data.

Referring to FIG. 4A and FIG. 4B, the static object detection module 233, including generated a local map including static object-related data at an n-lth step (e.g., a first time point (t=1)) as shown in FIG. 4A, may also generate and output a local map at an nth step (e.g., a second time point (t=2)) as shown in FIG. 4B according to the exemplary embodiments described above.

In FIG. 4B, reference numeral 3 indicates data associated with a static object that has passed validation, and reference numeral 33 indicates data associated with an object which is not a static object.

The static object detection module 233 may be configured to determine that the validation has passed when an average value of scores of grids including a LiDAR contour is greater than or equal to a predetermined threshold value. The validation may be passed only when an object is detected for a predetermined time period or greater in a specific section.

The static object detection module 233 may determine, as a static object, the LiDAR contour of the grids that have passed the validation.

A score of each grid may be the number of data output via the sensing device 10 to each grid for a predetermined time period (e.g., time steps). That is, the score of each grid may be determined by the number of data output and accumulated via the sensing device 10 in each grid during a plurality of time frames.

Furthermore, when an average value of scores of grids with low scores in a local map, that is, an average value of the scores of the grids including the LiDAR contour, is less than the predetermined threshold value, the LiDAR contour included in the corresponding grids may be clutter. It is highly likely that the grids with low scores are not detected by a plurality of sensors of the sensing device 10 or include data of an object which is not detected over multiple times.

Accordingly, when the average value of the scores of the grids including the LiDAR contour is less than the predetermined threshold value, the static object detection module 233 may be configured to determine the LiDAR contour included in the grids not to be a static object.

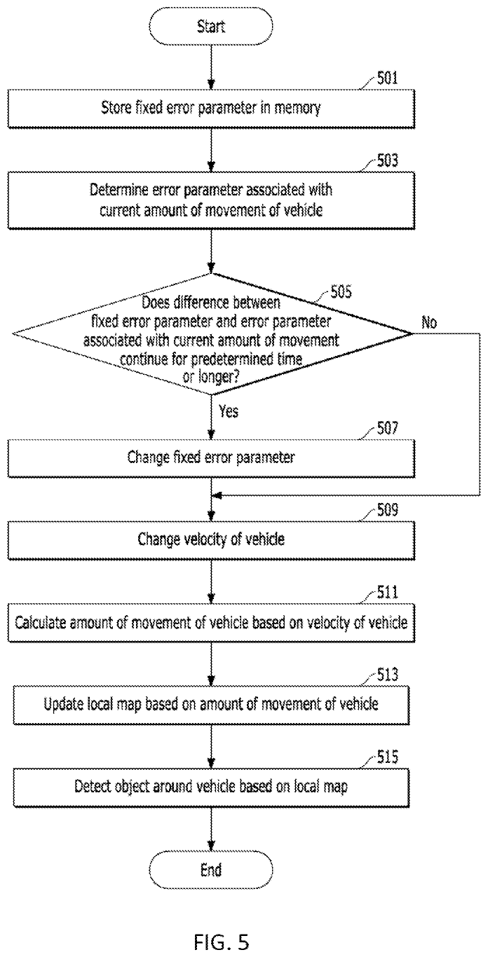

FIG. 5 is a flowchart illustrating operations of the object detection system 200 (and/or the control unit 230) of the vehicle 2 according to an exemplary embodiment of the present disclosure.

Referring to FIG. 5, in operation 501, the object detection system 200 may store a fixed error parameter determined through prior learning in the memory 220.

The fixed error parameter may be determined by the external system 2000 of the vehicle 2, the internal system of the vehicle 2, or the control unit 230 of the vehicle 2, and may be provided to the object detection system 200.

In operation 503, the object detection system 200 may be configured to determine an error parameter associated with a current amount of movement of the vehicle 2, through a predetermined regression method, based on output data of the VDISP sensor 21 and positioning information of the vehicle 2 output from the precise position sensor 22 or the localization module 23.

The error parameter associated with a current amount of movement of the vehicle 2 may be determined through Equation 3 described above. The error parameter associated with a current amount of movement of the vehicle 2 may include A (A=[Sₓ, r_{y}, bₓ] and A=Y₁/X₁) and B (B=[S_{y}, rₓ, b_{y}] and B=Y₂/X₂).

In operation 505, the object detection system 200 may be configured to determine whether a difference between the fixed error parameter and the error parameter associated with the current amount of movement is maintained for a predetermined time period or longer.

The object detection system 200 may be configured to determine a difference value between each of parameters included in the fixed error parameter and each of parameters included in the error parameter associated with the current amount of movement and determine whether a state in which the determined difference value is greater than or equal to the predetermined threshold value is maintained for the predetermined time period or longer.

The object detection system 200 may perform operation 507 when the difference between the fixed error parameter and the error parameter associated with the current amount of movement is maintained for the predetermined time period or longer, and otherwise perform operation 509.

For example, the object detection system 200 may be configured to determine whether a state in which a difference value between a movement vector from the center of gravity of the vehicle 2 to the center portion of the front bumper (the vehicle coordinate system) among parameters included in the fixed error parameter, and a movement vector from the center of gravity of the vehicle 2 to the center portion of the front bumper (the vehicle coordinate system) among parameters included in the error parameter associated with the current amount of movement is greater than or equal to a predetermined threshold value continues for a predetermined time period or longer. The object detection system 200 may perform operation 507 when the state in which the difference value between the movement vectors is greater than or equal to the predetermined threshold value continues for the predetermined time period or longer, and otherwise perform operation 509.

In operation 507, the object detection system 200 may change (or correct) the fixed error parameter stored in the memory 220.

The object detection system 200 may change and update the fixed error parameter stored in the memory 220 through Equation 4 described above.

For example, the object detection system 200 may change the movement vector from the center of gravity of the vehicle 2 to the center portion of the front bumper (the vehicle coordinate system), which is included in the fixed error parameter, through Equation 4 described above, and may store the changed one in the memory 220.

In operation 509, the object detection system 200 may change a velocity of the vehicle 2 relative to the center of gravity of the vehicle 2, based on the fixed error parameter stored in the memory 220.

The velocity of the vehicle 2 relative to the center of gravity may be included in the output data of the VDISP sensor 21.

The object detection system 200 may change (or correct) the velocity of the vehicle 2 relative to the center of gravity to one relative to the center portion of the front bumper of the vehicle 2, based on Equation 5 described above.

For example, when correcting the velocity of the vehicle 2 after operation 507, the object detection system 200 may use the fixed error parameter changed in operation 507.

For example, when it is determined that the difference between the fixed error parameter and the error parameter associated with the current amount of movement does not continue for the predetermined time period or longer in operation 505, the object detection system 200 may use the fixed error parameter which is not changed to correct the velocity of the vehicle 2 relative to the center of gravity.

In operation 511, the object detection system 200 may be configured to determine an amount of movement of the vehicle 2 based on the changed velocity of the vehicle 2.

The object detection system 200 may be configured to determine the amount of movement of the vehicle 2 by integrating a longitudinal velocity and a lateral velocity of the vehicle 2 in the vehicle coordinate system, based on the corrected velocity of the vehicle 2.

In operation 513, the object detection system 200 may update a local map based on the amount of movement of the vehicle 2.

The local map may include data output from the sensing device 10 of the vehicle 1 for a predetermined time period (or a predetermined time period step), based on the amount of movement of the vehicle 2.

In operation 515, the object detection system 200 may recognize an object around the vehicle 2 based on the local map.

The object detection system 200 may recognize an object, for example, a static object, around the vehicle 2, based on data output from the sensing device 20 (e.g., the object detection sensor 24) included in the local map.

For example, the object detection system 200 may score the data included in the local map, and when an average value of scores of neighboring grids including the data is greater than or equal to a predetermined threshold value, may be configured to determine the data included in the corresponding grids as a static object around the vehicle 2.

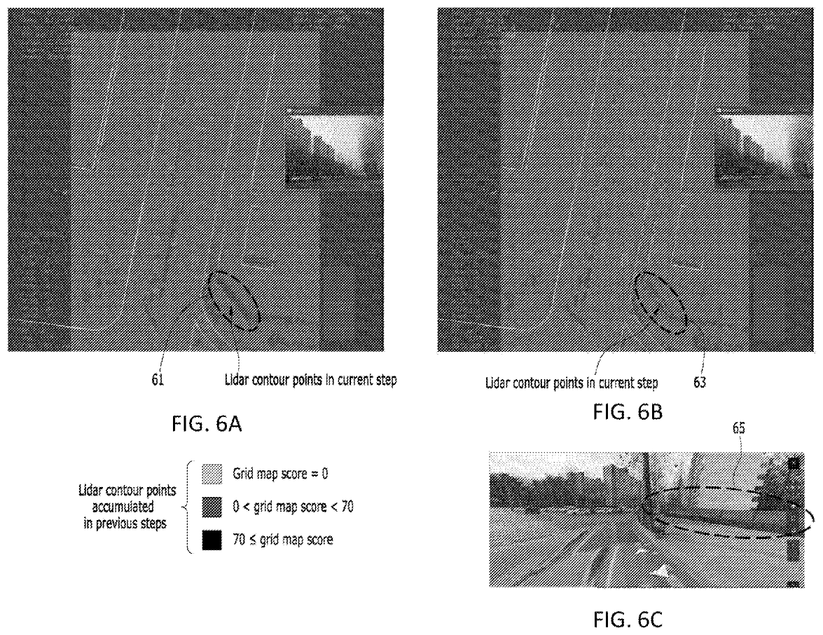

FIG. 6A, FIG. 6B and FIG. 6C are images showing a result of outputting a map including a local map according to the related art and an exemplary embodiment of the present disclosure.

An example map which is based on an amount of movement of the vehicle 2 with a large error, which is determined according to the related art, is shown in FIG. 6A.

An example map which is based on an amount of movement of the vehicle 2 with a minimized error, which is determined according to the exemplary embodiments of the present disclosure, is shown in FIG. 6B.

Reference numeral 61 of FIG. 6A and reference numeral 63 of FIG. 6B indicate a result of outputting a local map which is based on output data (e.g., a LiDAR contour point of the LiDAR 26) of the sensing device 20 for a static object indicated by reference numeral 65 of FIG. 6C.

In the local map of reference numeral 61 of FIG. 6A and the local map of reference numeral 63 of FIG. 6B, a LiDAR contour point of a current time step and LiDAR contour points accumulated in previous time steps may be included.

Referring to the local map 61 of FIG. 6A, it may be verified that the LiDAR contour points are distributed, and there is a great difference in position between the LiDAR contour point in the current time step and the LiDAR contour points accumulated in the previous time steps.

FIG. 6A shows a result that does not include a LiDAR contour point at an accurate position, because the local map is updated based on data output from a sensing device after an amount of movement of a vehicle is determined based on an inaccurate velocity.

Referring to the local map 63 of FIG. 6B, it may be verified that the LiDAR contour points are less distributed than in the local map 61 of FIG. 6A, and there is a smaller difference in position between the LiDAR contour point in the current time step and the LiDAR contour points accumulated in the previous time steps, compared to the local map 61 of FIG. 6A. The present shows a result with a reduced position error of the LiDAR contour points, compared to that of FIG. 6A, because the local map is updated based on data output from the sensing device 20 after an amount of movement of the vehicle 2 is determined based on a velocity improved from the related art in terms of inaccuracy.

The number of LiDAR contour points accumulated in the previous time steps may be a score of grids of the local map 61, and it may be verified that an average of respective scores of the grids of the local map 61 is less than an average of respective scores of grids of the local map 63 of FIG. 6B.

According to the exemplary embodiments of the present disclosure, the presence or absence of a static object may be recognized based on the average of the scores of the grids. The average score of the local map 61 of FIG. 6A is relatively lower, and thus the static object 65 may not be recognized when recognizing an object based on the local map 61 of FIG. 6A.

The exemplary embodiments of the present disclosure described above may be implemented in the form of a recording medium storing instructions executable by a computer. The instructions may be stored in the form of program code, which, when executed by a processor, may be configured to generate program modules to perform the operations of the exemplary embodiments of the present disclosure. The recording medium may be implemented as a computer-readable medium.

The computer-readable medium includes all types of recording devices in which computer-readable instructions are stored. The computer-readable medium includes, as non-limiting examples, read-only memory (ROM), random-access memory (RAM), magnetic tape, magnetic disk, flash memory, optical data storage, and the like.

The exemplary embodiments of the present disclosure have been described above with reference to the accompanying drawings.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular form may also include a plural form. The expression “at least one (or one or more) of A, B, and C” may include one or more of all combinations that may be made by combining A, B, and C.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalent.

What is claimed is:

1. An object detection method, comprising:
determining, by a processor, an error parameter associated with an amount of movement of a vehicle through a predetermined regression method based on positioning information of the vehicle and dynamics information of the vehicle with respect to a predetermined center of gravity of the vehicle;
determining, by the processor, a velocity of a predetermined point of the vehicle, based on a fixed error parameter stored in a memory or a corrected fixed error parameter, through a comparison between the error parameter and the fixed error parameter;
generating, by the processor, a local map in consideration of the amount of movement of the vehicle based on the determined velocity; and
detecting, by the processor, an object around the vehicle based on the local map.

2. The object detection method of claim 1, further including:
in response to a difference between the error parameter and the fixed error parameter being greater than or equal to a predetermined threshold value, correcting the fixed error parameter via a low-pass filter (LPF) to generate the corrected fixed error parameter.

3. The object detection method of claim 2, wherein, the determining of the velocity includes:
determining the velocity based on the corrected fixed error parameter in response to the difference being greater than or equal to the predetermined threshold value, and
determining the velocity based on the fixed error parameter in response to the difference being less than the predetermined threshold value.

4. The object detection method of claim 1, wherein the fixed error parameter is determined and provided through prior learning by an external system of the vehicle.

5. The object detection method of claim 4, wherein the fixed error parameter includes a scale factor of an output velocity of a vehicle dynamics input signal processing (VDISP) sensor of the vehicle, a bias of the output velocity, and a vector from the center of gravity of the vehicle to the predetermined point of the vehicle.

6. The object detection method of claim 1,
wherein the dynamics information includes a first velocity and a yaw rate output from a VDISP sensor of the vehicle, and
wherein the determining of the error parameter associated with the amount of movement of the vehicle is performed based on a second velocity of the vehicle determined based on the positioning information of the vehicle.

7. The object detection method of claim 6, wherein the error parameter associated with the amount of movement of the vehicle includes a scale factor of the first velocity, a bias of the first velocity, and a vector from the predetermined center of gravity to the predetermined point of the vehicle.

8. The object detection method of claim 1, wherein the amount of movement of the vehicle is determined by integrating a longitudinal velocity and a lateral velocity included in the determined velocity.

9. The object detection method of claim 1, wherein the generating of the local map includes generating the local map including data output from an object detection sensor of the vehicle, based on pre-stored map data, the amount of movement of the vehicle, the positioning information of the vehicle, and the data output from the object detection sensor.

10. The object detection method of claim 9,
wherein the local map includes a grid map, and
wherein the detecting of the object includes:
determining a score for each grid based on a number of data output from the object detection sensor and accumulated therein for a predetermined time period; and
in response to an average value of scores of neighboring grids which include the data being greater than or equal to a predetermined threshold value, determining data of the neighboring grids as data of a static object.

11. An object detection system, comprising:
an interface configured to receive, from a sensing device of a vehicle, positioning information of the vehicle and dynamics information with respect to a predetermined center of gravity of the vehicle;
a memory configured to store a fixed error parameter; and
a processor electrically or communicatively connected to the interface and the memory,
wherein the processor is configured to:
determine an error parameter associated with an amount of movement of the vehicle through a predetermined regression method based on the positioning information and the dynamics information,
determine a velocity of a predetermined point of the vehicle, through a comparison between the error parameter and the fixed error parameter, based on the fixed error parameter or a corrected fixed error parameter,
generate a local map in consideration of the amount of movement of the vehicle based on the determined velocity, and
detect an object around the vehicle based on the local map.

12. The object detection system of claim 11, wherein the processor is further configured to:
in response to a difference between the error parameter and the fixed error parameter being greater than or equal to a predetermined threshold value, correct the fixed error parameter via a low-pass filter (LPF) to generate the corrected fixed error parameter.

13. The object detection system of claim 12, wherein the processor is further configured to:
in response to the difference being greater than or equal to the predetermined threshold value, determine the velocity of the predetermined point of the vehicle based on the corrected fixed error parameter; and
in response to the difference being less than the predetermined threshold value, determine the velocity of the predetermined point of the vehicle based on the fixed error parameter.

14. The object detection system of claim 11, wherein the fixed error parameter is determined through prior learning by an external system of the vehicle and provided via the interface.

15. The object detection system of claim 14, wherein the fixed error parameter includes a scale factor of an output velocity of a vehicle dynamics input signal processing (VDISP) sensor of the vehicle, a bias of the output velocity, and a vector from the center of gravity of the vehicle to the predetermined point of the vehicle.

16. The object detection system of claim 11,
wherein the dynamics information includes a first velocity and a yaw rate output from a VDISP sensor of the vehicle, and
wherein the processor is further configured to determine the error parameter associated with the amount of movement of the vehicle based on a second velocity of the vehicle determined based on the positioning information of the vehicle.

17. The object detection system of claim 16, wherein the error parameter associated with the amount of movement of the vehicle includes a scale factor of the first velocity, a bias of the first velocity, and a vector from the predetermined center of gravity to the predetermined point of the vehicle.

18. The object detection system of claim 11, wherein the processor is further configured to determine the amount of movement of the vehicle by integrating a longitudinal velocity and a lateral velocity comprised in the determined velocity.

19. The object detection system of claim 11,
wherein the memory is further to store map data, and
wherein the processor is further configured to generate the local map including data output from an object detection sensor of the vehicle, based on the map data, the amount of movement of the vehicle, the positioning information of the vehicle, and the data output from the object detection sensor.

20. The object detection system of claim 19,
wherein the local map includes a grid map, and
wherein the processor is further configured to:
determine a score for each grid based on a number of data output from the object detection sensor and accumulated therein for a predetermined time period; and
in response to an average value of scores of neighboring grids which include the data being greater than or equal to a predetermined threshold value, determine data of the neighboring grids as data of a static object.
